(19) United States
(12) Patent Application Publication
(10) Pub. No.: US 2014/0085142 A1
(43) Pub. Date: Mar. 27, 2014

(54) COLLABORATIVE ASSISTED GLOBAL POSITIONING SYSTEM

(71) Applicants: Michael Baruch, Bnei brak (IL); Ory Eger, Tel Aviv (IL)

(72) Inventors: Michael Baruch, Bnei brak (IL); Ory Eger, Tel Aviv (IL)

(21) Appl. No.: 13/629,315

(22) Filed: Sep. 27, 2012

(51) Int. Cl. G01S 19/25

(52) U.S. Cl. 342/357.64

(57) ABSTRACT

An system and method for assisting global positioning system (GPS) receivers in acquiring and tracking satellites. A method for assisting GPS receivers in acquiring and tracking satellites includes receiving satellite parameters of at least one satellite visible to at least one GPS receiver. The method further includes receiving a request for assistance from a requesting GPS receiver and assisting the requesting GPS receiver in acquisition and tracking using the received satellite parameters.

### TECHNICAL FIELD

Embodiments pertain to wireless communications. Some embodiments relate to assisted global positioning systems (AGPS) in wireless access networks.

### BACKGROUND

User equipment (UEs) may provide global positioning system (GPS) capabilities, such as location-based services, using radio signals from satellites. When signal conditions for these signals are particularly poor, it may take a substantial amount of time for a UE to acquire and track satellites. Therefore, Assisted GPS (AGPS) servers may supply additional data to UEs to reduce the amount of time required for a UE to acquire and track satellites, or to provide more accurate acquisition and tracking. For example, an AGPS server may provide satellite orbital data or status data to the GPS receiver of a UE, enabling the UE to lock to the satellites more rapidly. AGPS servers may provide information for a set of satellites based on, for example, the general position of the UE or other information previously known about the UE.

In current AGPS systems, the AGPS server may provide information for satellites that cannot be acquired or tracked by a UE, or that can only be acquired or tracked with difficulty. For example a satellite for which the AGPS is providing information may not be within the line of sight of the UE because the satellite signal is blocked by an intervening structure. As a result, the UE may consume power in a vain search for that satellite.

Thus, there are general needs for AGPS servers and methods that provide assistance to a UE in acquiring and tracking satellites based on accurate information specific to the neighborhood of a requesting UE. Also needed are UEs and methods that provide accurate, on-the ground information concerning signal status of satellites.

### BRIEF DESCRIPTION OF THE DRAWINGS

FIG. 1 illustrates an example portion of a network according to some embodiments.

FIG. 2 illustrates an example method for assisting a user equipment (UE) in acquiring and tracking satellites, in accordance with some embodiments.

FIG. 3 illustrates a protocol message providing satellite parameters.

FIG. 4 illustrates elements of an assisted global positioning system (AGPS) server in accordance with some embodiments.

FIG. 5 illustrates a UE in accordance with some embodiments.

### DETAILED DESCRIPTION

The following description is presented to enable any person skilled in the art to create and use a computer system configuration and related method and article of manufacture to provide assistance, in collaboration with user equipment (UEs) and global positioning system (GPS) receivers, to user equipment (UEs) attempting to acquire and track one more GPS satellites. Assistance is provided by an assisted GPS (AGPS) server using information collaboratively provided by other UEs or by specially-placed GPS receivers. In at least one example embodiment, parameters and other data of GPS satellites are stored in a memory such that the parameters and other data are further associated with the UE or GPS receiver that transmitted the information. In at least one example embodiment, upon receiving a request for assistance in acquiring and tracking satellites from a requesting UE, an AGPS server can access the memory to retrieve information that was transmitted by UEs and GPS receivers located near the requesting UE, so that assistance data provided to the UE is refined using data customized to the requesting UE's location.

Various modifications to the embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that embodiments of the invention may be practiced without the use of these specific details. In other instances, well-known structures and processes are not shown in block diagram form in order not to obscure the description of the embodiments of the invention with unnecessary detail. Thus, the present disclosure is not intended to be limited to the embodiments shown, but is to be accorded the widest scope consistent with the principles and features disclosed herein.

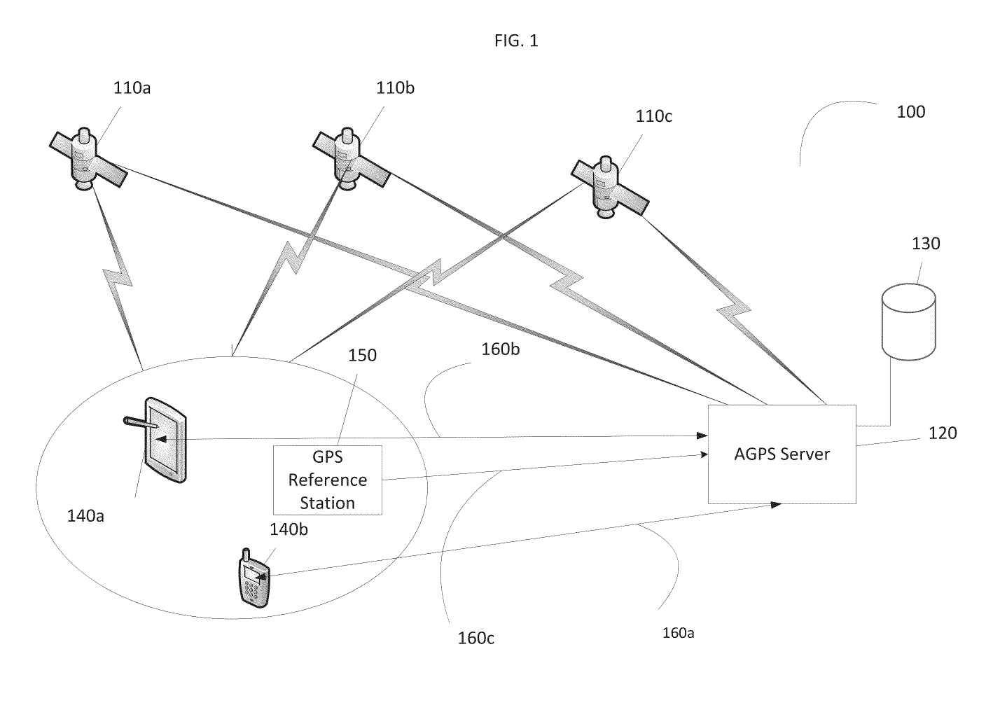

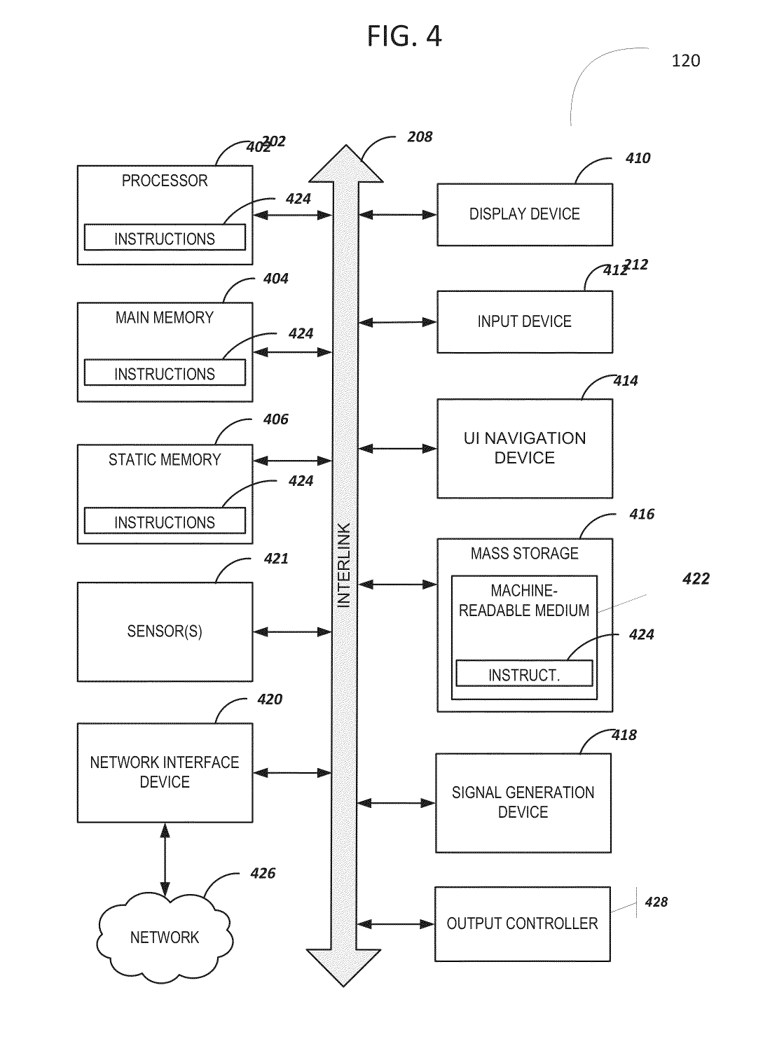

FIG. 1 illustrates elements of a collaborative assisted GPS (AGPS) navigation system 100. The system 100 includes a plurality of satellites 110a, 110b, and 110c. It will be understood that the system 100 may include more or fewer than three satellites. The system 100 further includes at least one AGPS Server 120 and AGPS database 130. The AGPS database 130 may be a separate entity from the AGPS Server 120 or the AGPS database 130 may be incorporated within the AGPS Server 120. The system for implementing the AGPS Server 120 is described in more detail below with respect to FIG. 4.

The AGPS Server 120 communicates real-time GPS satellite data, for example, ephemeris data or almanac data, to a plurality of UEs 140a, 140b over connections 160a, 160b. It will be understood that the system 100 may include more or fewer UEs. Ephemeris data is used to calculate the position of each satellite in orbit. Almanac data is information about the time and status of the entire GPS satellite constellation.

The AGPS Server 120 may further receive GPS satellite data from one or more of UEs 140a, 140b over connections 160a, 160b. The system 100 may further include at least one GPS reference station 150 deployed by, for example, a mobile network operator (MNO) for the purpose of taking GPS satellite measurements. The GPS reference station 150 may transmit these measurements over communications link 160c to the AGPS Server 120.

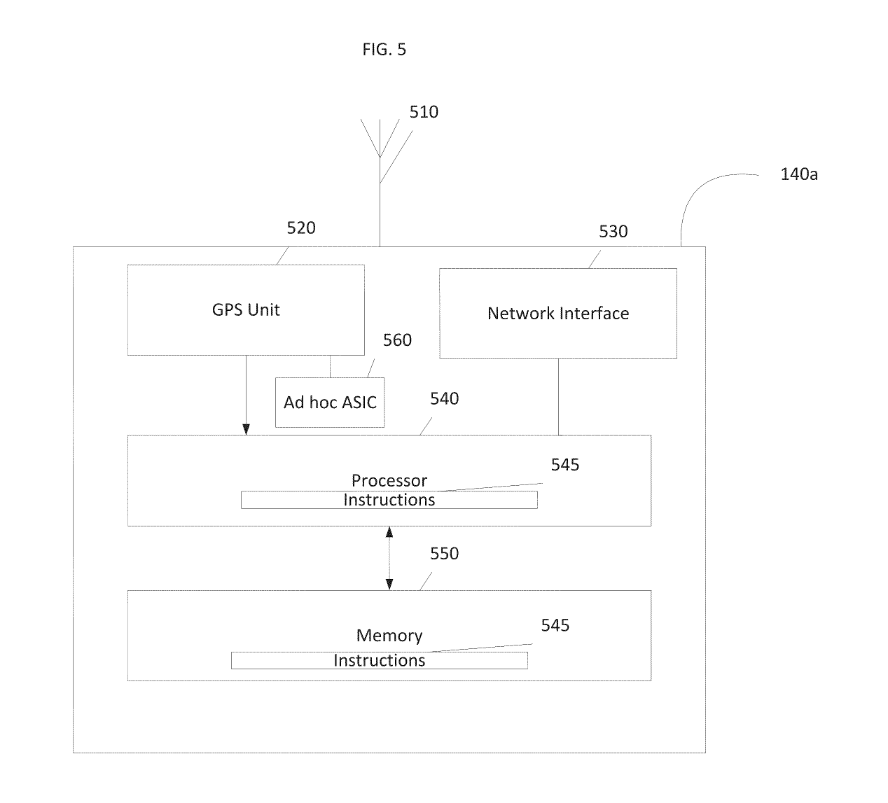

Links 160a through 160c may operate over a communication network or combination of communication networks including, for example, a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi, IEEE 802.16 family of standards known as WiMax), peer-to-peer (P2P) networks, etc. The UEs 140a, 140b may be, for example, laptops, smartphones, or other mobile devices, capable of providing location-based services to users. The UEs 140a, 140b may comprise suitable logic circuitry and/or code to enable the UEs 140a, 140b to receive satellite transmission signals from the GPS satellites 110a through 110c to determine the position of the UEs 140a 140b. The UEs 140a, 140b are described in more detail below with respect to FIG. 5.

The AGPS Server 120 may allow the UEs 140a, 140b to acquire and track satellites 110a through 110c relatively quickly in low signal-to-noise ratio (SNR) environments. The data provided by an AGPS Server 120 may be further customized based on the positions of the UEs 140a, 140b. For example, the AGPS Server 120 may find an estimated location of the UEs 140a, 140b within a certain radius, and then assist the UEs 140a, 140b in acquiring and tracking the satellites 110a through 110c that should be visible to the UEs 140a, 140b at that estimated location. Without the assistance of an AGPS Server 120, a UE 140a, 140b may otherwise be required to constantly download almanac data and ephemeris data from satellites, and this data may not always be available or downloads may take an unacceptably long amount of time.

Nevertheless, the AGPS Server 120 may provide assistance information for satellites that are not truly visible to the UEs 140a, 140b because of the “urban canyon” phenomenon. For example, a satellite, which the AGPS Server 120 has determined should be visible to the UEs 140a, 140b, may actually not be visible because of an intervening structure, such as a building, between the satellite and the UEs 140a, 140b. The UEs 140a, 140b may therefore experience a relatively long time to first fix (TTFF) as the UEs 140a, 140b attempt to acquire and track these satellites.

As a further example, assistance parameters provided by the AGPS Server 120 may be inaccurate if satellite signals rebound from buildings or structures before reaching the UEs 140a, 140b. For example, multipath errors may be introduced such that satellite signals are reflected and take a longer time to reach the UEs 140a, 140b than a direct, unreflected satellite signal would have taken. Because the satellite-to-receiver transmission time offset is typically used to positioning, assistance parameters for these satellites may result in ranging and positioning errors at the UE 140a, 140b. In example embodiments, if the AGPS Server 120 determines that these satellites would not be useful for UEs 140a, 140b, the AGPS Server120 may remove information related to these satellites from the aiding message. In other example embodiments, the AGPS Server 120 may assign these satellites a relatively low rank and inform the UEs 140a, 140b of this low rank in the aiding messages.

Further, when a UE 140a, 140b has already acquired and tracked satellites, the UEs 140a, 140b may request assistance from the AGPS Server 120 in order to improve the accuracy of this acquisition and tracking. However, if the UEs 140a, 140b remain in the same position, the AGPS Server 120 will continue to provide the same aiding information and the accuracy of the acquisition and tracking will not change. This results in a lost opportunity for the AGPS Server 120 to improve accuracy for UEs 140a, 140b.

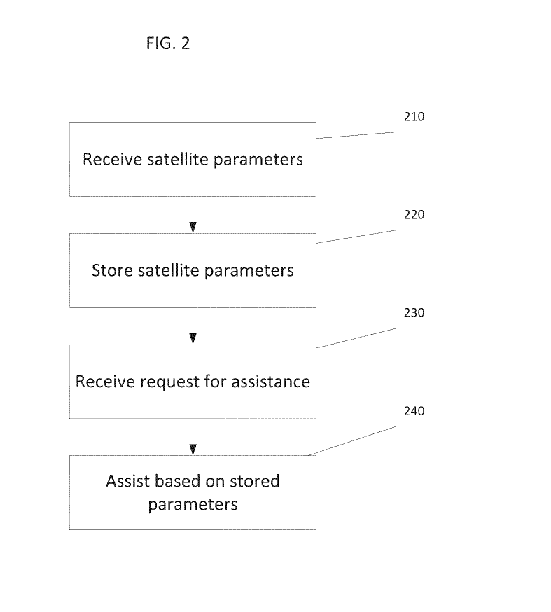

Example embodiments use satellite parameter data provided by nearby UEs, or by specially-placed GPS reference stations 150, in combination with global GPS data, to provide refined assistance data to assist UEs in acquiring and tracking satellites 110a through 110c. In this way satellite parameter data, captured by UEs and GPS reference stations neighboring the requesting UE, may be used to reduce or eliminate errors due to, for example, the urban canyon effect. The refined assistance data may allow a UE 140a, 140b to acquire and track satellites more quickly, using less power. A method for assisting a UE 140a, 140b in acquiring and tracking satellites is described below with respect to FIG. 2.

Referring to FIG. 2, in operation 210, the AGPS Server 120 receives satellite parameters from at least one GPS receiver. For example, the AGPS Server 120 may receive satellite parameters from one or more of the UEs 140a, 140b, or the GPS reference station 150. The satellite parameters may include, for example, multipath information for at least one satellite 110a through 110c as seen by the transmitting UEs 140a, 140b or the GPS reference station 150. In an example embodiment, the AGPS Server 120 may receive this data in a message complying with an AGPS standard protocol, such as Secure User Plane Location (SUPL) protocol, although this is not a requirement. In an example embodiment, the AGPS Server 120 may receive this data in a message complying with Control Plane (C-Plane) standards, although this is not a requirement.

The UEs 140a, 140b may automatically transmit satellite parameters to the AGPS Server 120, or a user of the UEs 140a, 140b may manually transmit satellite parameters to the AGPS Server 120. For example, a user may note that he or she has difficulty obtaining GPS services in a location, and the user may therefore decide to manually transmit satellite information using his or her UE 140a, 140b.

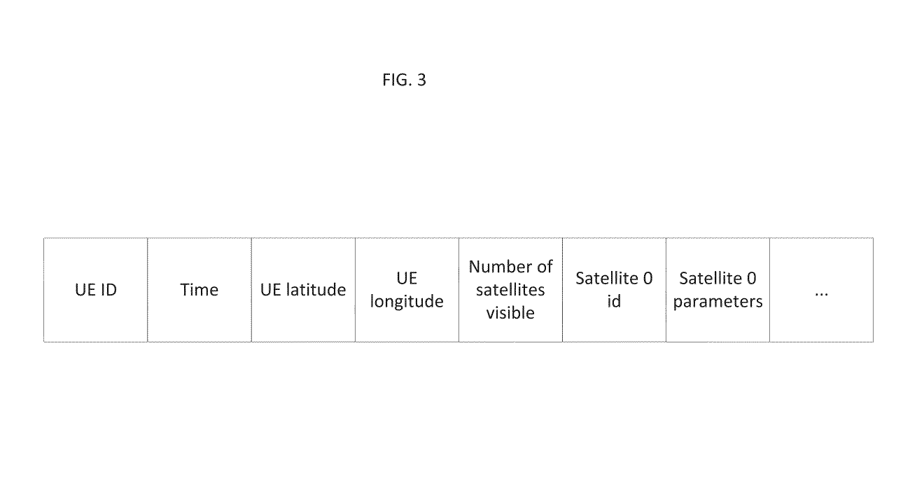

FIG. 3 illustrates an example structure of a message received from a UE 140a, 140b that includes satellite parameters in accordance with example embodiments. The message may include, for example, an identifier for the UE 140a, 140b. The message may include the time of day at which the message is being sent. The time of day may be expressed in, for example, seconds. The message may include the position of the UE 140a, 140b expressed as, for example, latitudinal and longitudinal coordinates. The message may include the number of satellites for which the UE 140a, 140b is reporting parameters. The message may still further include identifying information for at least one satellite, and parameter information, for example measurements as seen by the UE 140a, 140b for at least one satellite visible to the UE 140a, 140b.

Referring again to FIG. 2, in operation 220, the AGPS Server 120 stores the received parameters in a memory. In an embodiment, the AGPS Server 120 stores the received parameters in the AGPS database 130. The AGPS Server 120 stores the received parameters such that the received parameters can be related back to the UE 140a, 140b or GPS reference station 150 that transmitted the parameters. The AGPS Server 120, therefore, may store identifying information such as the identifier or location information for the UE 140a, 140b, or the GPS reference station 150 that transmitted the parameters. The AGPS Server 120 may further store the time, for example in the form of a timestamp, at which the parameters were sent by the GPS receiver.

In operation 230, the AGPS Server 120 receives a request for assistance in acquiring and tracking satellites. The request may be received from UE 140a, 140b over a network connection 160a, 160b. In an example embodiment, the UE 140a, 140b has not yet acquired or tracked any satellites and requires assistance for a first-instance acquisition and tracking of satellites. In another example embodiment, the UE 140a, 140b has acquired and tracked satellites and requests refinement of the acquisition and tracking. In an example embodiment, the UE 140a, 140b has determined that a previous acquisition and tracking of satellites is not within a required accuracy, and the UE 140a, 140b is therefore requesting assistance for a more accurate acquisition and tracking of satellites.

In operation 240, the AGPS Server 120 assists the requesting UE 140a, 140b in acquiring and tracking satellites. In order to determine satellites for which the AGPS Server 120 will transmit assistance data, the AGPS Server 120 may determine a position or approximate position of the requesting UE 140a, 140b. Using this position, the AGPS Server 120 may determine possible satellites visible to UEs in that area.

The AGPS Server 120 may access memory, for example the AGPS database 130, to retrieve satellite parameter data that was transmitted by neighboring GPS receivers, for example UEs 140a, 140b and GPS reference station 150, within a threshold distance of the requesting UE 140a, 140b. The retrieved satellite parameter data may be parameter data for one satellite or for multiple satellites. The AGPS Server 120 may retrieve satellite parameter data that was transmitted by GPS receivers at the same or similar time of day, on the same day or previous days, at which the UE 140a, 140b requests assistance.

The AGPS Server 120 may perform statistical functions, smoothing functions, averaging functions, combining functions, or ranking functions on the satellite parameter data for satellite parameter data that may have been transmitted by multiple different GPS receivers. The AGPS Server 120 may use the retrieved data to refine previously-estimated assistance data before transmitting the assistance data to the requesting UE 140a, 140b. The AGPS Server 120 may transmit the refined assistance data to the requesting UE 140a, 140b in a format compatible with GSM/UMTS, Wi-Fi, WiMax, or SUPL, as illustrative examples.

Before providing assistance data or refined assistance data, the AGPS Server 120 may generate a list of candidate satellites for which the AGPS Server 120 which are likely to be used by the requesting UE 140a, 140b. The AGPS Server 120 may remove candidate satellites from the list based on data related to that satellite that is retrieved from the memory, for example from the AGPS database 130. The list of candidate satellites may include satellites that the requesting UE 140a, 140b has already acquired and tracked.

FIG. 4 illustrates a block diagram of an example machine 120 upon which any one or more of the operations performed by the AGPS Server discussed above may be performed. In alternative embodiments, the machine 120 may operate as a standalone device or may be connected (e.g., networked) to other machines. For example, the machine 120 may be networked to a machine for implementing the AGPS database 130. In a networked deployment, the machine 120 may operate in the capacity of a server machine, a client machine, or both in server-client network environments. In an example, the machine 120 may act as a peer machine in a peer-to-peer (P2P) (or other distributed) network environment.

Machine (e.g., computer system) 120 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 120 may further include a display unit 410, an alphanumeric input device 412 (e.g., a keyboard), and a user interface (UI) navigation device 411 (e.g., a mouse). The machine 120 may additionally include a storage device (e.g., drive unit) 416, a signal generation device 418 (e.g., a speaker), and a network interface device 420. The network interface device 420 may be arranged to receive satellite parameters from GPS receivers.

The machine may further include one or more sensors 421, such as a global positioning system (GPS) sensor, compass, accelerometer, or other sensor. The machine 120 may include an output controller 428, such as a serial (e.g., universal serial bus (USB), parallel, or other wired or wireless (e.g., infrared (IR)) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 120. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) that arranged to store the one or more instructions 424.

The term “machine readable medium” may include any medium that is capable of storing, encoding, or carrying instructions for execution by the machine 120 and that cause the machine 120 to perform any one or more of the techniques of the present disclosure, or that is capable of storing, encoding or carrying data structures used by or associated with such instructions. For example, the instructions may cause the machine 120 to receive requests for assistance in acquiring and tracking satellites, store satellite parameters in memory such that the satellite parameters are associated with the GPS receiver that transmitted the satellite parameters, and assist a requesting GPS receiver in handling multipath scenarios to acquire and track at least one satellite based on the stored satellite parameters.

Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). The term “transmission medium” shall be taken to include any intangible medium that is capable of storing, encoding or carrying instructions for execution by the machine 120, and includes digital or analog communications signals or other intangible medium to facilitate communication of such software. The instructions 424 may implement algorithms for assisting UEs 140a, 140b in acquiring and tracking satellites using collaborative satellite parameter data from the UEs 140a, 140b and GPS reference station 150, according to embodiments described herein.

FIG. 5 illustrates a UE in accordance with some embodiments. Referring to FIG. 5, the UE 140a includes an antenna 510, a GPS unit 520, a network interface 530, a processor 540, instructions 545, and a memory 550.

The UE 140a may include one or more antennas 510 arranged to communicate with a base station (BS), an evolved Node B (eNodeB), or other type of wireless lcoal area network (WLAN) access point. The UE 140a may be configured to communicate using at least one wireless communication standard including 3GPP LTE, WiMax, High Speed Packet Access (HSPA), Bluetooth, and Wi-Fi. The UE 140a may communicate using separate antennas 510 for each wireless communication standard or shared antennas for multiple wireless communication standards.

The antenna 510 may further enable UE 140a to receive signals from a plurality of satellites 110a through 110c. The antenna 510 may further enable the UE 140a to transmit and receive signals over, for example, mobile telephone networks (e.g., cellular networks), so that the UE 140a may communicate with the AGPS Server 120. In some embodiments, separate antennas are used for GPS and for other communication protocols.

The GPS unit 520 enables the UE 140a to receive GPS satellite broadcast signals via the antenna 510. The GPS unit 520 may measure parameters of at least one satellite visible to the UE 140a. The GPS satellite signals may be processed, in conjunction with data received from the AGPS Server 120, by the processor 540.

The network interface 530 enables the UE 140a to transmit or receive radio signals over a communication network through the antenna 510. In an embodiment, the network interface 530 enables the UE 140a to transmit parameters of signals of at least one satellite visible to the UE 140a. The received signals may include signals received from the AGPS Server 120, and these received signals may include assistance data generated by the AGPS Server 120 in response to AGPS assistance requests transmitted by the UE 140a. In an embodiment, the network interface 530 enables the UE 140a to request assistance, from the AGPS Server 120, in acquiring and tracking satellites. In an embodiment, the network interface 530 enables the UE 140a to receive parameters of signals of at least one satellite that is visible to a neighboring UE, the neighboring UE being within a threshold distance of the UE 140a.

The processor 540 may include logic or code to enable the UE 140a to process received satellite signals and signals received from the network through the antenna 510. The processor 540 may include code or other instructions 545 to compute a position by combining GPS measurements with assistance data received from the AGPS Server 120. The UE 140a may include an ad hoc application specific integrated circuit (ASIC) 560. The instructions may additionally or alternatively reside in the memory 550. The memory 550 may further store GPS data and assistance data received from the AGPS Server 120. In addition to a processor 540, the UE may include ad hoc ASIC hardware (not shown).

It will be appreciated that, for clarity purposes, the above description describes some embodiments with reference to different functional units or processors. However, it will be apparent that any suitable distribution of functionality between different functional units, processors or domains may be used without detracting from embodiments of the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the scope of the invention.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method for assisting global positioning system (GPS) receivers in acquiring and tracking satellites, the method comprising:
receiving, from at least one GPS receiver, satellite parameters of at least one satellite visible to the at least one GPS receiver;
receiving, from a requesting GPS receiver, a request for assistance in acquisition and tracking of satellites; and
assisting the requesting GPS receiver in acquisition and tracking of at least one satellite based on the satellite parameters.

2. The method of claim 1, wherein the assisting further comprises:
determining a position of the requesting GPS receiver;
generating, based on positions of a plurality of satellites, and on the position of the requesting GPS receiver, aiding data for assisting the requesting GPS receiver in acquiring and tracking satellites;
retrieving, from the memory, parameters for satellites associated with at least one neighboring GPS receiver, the at least one neighboring GPS receiver being within a threshold distance of the requesting GPS receiver; and
refining the aiding data based on the parameters retrieved from the memory.

3. The method of claim 1, further comprising:
determining an initial set of candidate satellites for acquisition and tracking by the requesting GPS receiver; and
removing at least one satellite from the initial set of candidate satellites based on stored parameters related to the at least one removed satellite.

4. The method of claim 3 wherein the initial set includes the satellites that the requesting GPS receiver has acquired and tracked.

5. The method of claim 1, wherein the signal parameters of at least one satellite are received from a GPS receiver of a mobile user.

6. The method of claim 1, wherein the signal parameters of at least one satellite are received from a GPS receiver designated for providing parameters of signals of at least one satellite.

7. The method of claim 1, wherein the parameters include at least multipath information related to the signals of the at least one satellite.

8. The method of claim 1 wherein the parameters include at least timing information of the signals of the at least one satellite.

9. The method of claim 1 wherein the received request is a request for a second acquisition and tracking of satellites based on a determination that a first acquisition and tracking of satellites is not within a threshold accuracy.

10. An assisted global positioning system (AGPS) server, comprising:
one or more processors;
a memory; and
an interface to communicate with a plurality of global positioning satellite (GPS) receivers, the interface being arranged to
receive satellite parameters, from at least one of the plurality of GPS receivers, for at least one satellite visible to the at least one GPS receiver of the plurality of GPS receivers; and
receive requests for assistance in acquiring and tracking satellites from requesting GPS receivers of the plurality of GPS receivers;
the one or more processors arranged to assist a requesting GPS receiver in handling multipath scenarios to acquire and track at least one satellite based on received satellite parameters.

11. The AGPS of claim 10, wherein the one or more processors are further arranged to store the satellite parameters in the memory such that the satellite parameters are associated with the at least one GPS receiver that transmitted the satellite parameters.

12. The AGPS of claim 11, wherein the one or more processors are further arranged to:
determine a position of the requesting GPS receiver;
generate, based on positions of a plurality of satellites, aiding data for assisting the requesting GPS receiver in acquisition and tracking of satellites;
retrieve, from the memory, parameters for satellites associated with at least one neighboring GPS receiver, the at least one neighboring GPS receiver being within a threshold distance of the requesting GPS receiver; and
refine the aiding data based on the parameters retrieved from the memory.

13. The AGPS of claim 11, wherein the one or more processors are further arranged to:
generate statistics of the satellite parameters stored in the memory based on current measurements of the satellite parameters and previous measurements of the satellite parameters.

14. A user equipment (UE) operating in a wireless communication network, comprising:
a global positioning system (GPS) receiver arranged to measure parameters of at least one satellite visible to the UE; and
a communications module arranged to
transmit the measured parameters to an assisted GPS (AGPS) server in the wireless communications network;
request assistance from the AGPS in acquisition and tracking of satellites; and
receive, in response to the request for assistance, parameters of signals of at least one satellite that is visible to at least one other UE within a threshold distance of the UE.

14. UE of claim 13, wherein the request is based on a determination that a first acquisition and tracking of satellites is not within a threshold accuracy.

15. The UE of claim 13, wherein the UE transmits satellite parameters according to an AGPS standard.

16. The UE of claim 15, wherein the UE transmits satellite parameters according to a C-PLANE standard.

17. The UE of claim 15, wherein the UE transmits satellite parameters according to a SUPL standard.
